(19) United States
(12) Patent Application Publication
(10) Pub. No.: US 2010/0295437 A1
(43) Pub. Date: Nov. 25, 2010

(54) HEAT DISSIPATION STRUCTURE OF A LED LIGHT

(76) Inventor: Sheng-Hsiung CHENG, Shu Lin City (TW)

Correspondence Address: LEONG C. LEI, PMB # 1008, 1839 YGNACIO VALLEY ROAD, WALNUT CREEK, CA, 94598, US

(21) Appl. No.: 12/469,704

(22) Filed: May 21, 2009

(51) Int. Cl. H01J 61/52

(52) U.S. Cl. 313/46

(57) ABSTRACT

Heat dissipation structure of a LED light is disclosed. The heat dissipation structure comprises a securing plate, and a plurality of heat conductive elements. The securing plate is provided with a plurality of first connection holes for the connection by insertion of the LED legs, and a plurality of second connection holes for the connection by insertion of heat dissipation elements, and a plurality of third connection holes in parallel and corresponding to the second connection holes, such that the first and second connection holes are mutually connected by conductive layer. The third connection holes are provided with independent conductive layer such that when the LED is mounted onto the first connection holes and the second and third connection holes are connected with heat conductive elements, the legs of the LEDs are soldered to the conductive layer forming into a LED light.

### TECHNICAL FIELD OF THE INVENTION

The present invention relates to heat dissipation structure, and in particular, a heat dissipation structure of a LED light which is cheap in manufacturing and provides excellent dissipation of heat with small size in structure.

### DESCRIPTION OF THE PRIOR ART

LED has the advantages of low current consumption and high brightness. Currently, LED lights are widely exploited and are employed in various types of products. However, LED elements generally generate substantial amount of heat which affects the longevity of the LED lights. Thus, LED light structure is provided with heat dissipation structure which dissipates heat and allows the LED light to function normally. Conventional heat dissipation structure of LED light normally has a substantially large surface area and is provided with rows of heat dissipation fins as the essential elements for heat dissipation. Thus, the entire size of the LED light cannot be minimized and the cost of manufacturing is high. The conventional LED lights are less competitive as a result of the manufacturing cost. Accordingly it is an object of the present invention to provide a heat dissipation structure and a LED light which mitigates the above-mentioned drawbacks.

### SUMMARY OF THE INVENTION

Accordingly, it is an object of the present invention to provide a heat dissipation structure of a LED light comprising a securing plate having a plurality of first connection holes and second connection holes and third connection holes in parallel with and in corresponding with the second connection holes such that the first connection holes and the second connection holes are mutually connected with a conductive layer, wherein the third connection holes are provided with an independent conductive layer; a plurality of LED connected onto the connection holes of the securing plate and soldered onto the conductive layer of the securing plate; a heat conductive element connected onto the second and third connection hole of the securing plate and soldered onto the conductive layer of the securing plate; thereby where the LED lights, generated heat is dissipated via the extended area formed by the conductive layer of the securing plate and the connection legs of a specific extended length of the LED and the conductive elements connected to the LED legs.

Yet still another object of the present invention to provide a heat dissipation structure and a LED light, wherein the heat conductive element is a substantially inverted “U” shaped with legs made from iron for soldering or other metal which is solderable.

A further object of the present invention is to provide a heat dissipation structure and a LED light, wherein the securing plate is a circuit board and the conductive layer is printed circuit on the circuit board.

Another object of the present invention is to provide a heat dissipation structure and a LED light, wherein the printed circuit is either single face or double faces which enhance(s) area for heat dissipation.

Other objects, and advantages will become more apparent in view of the following detailed description in conjunction with the accompanying drawings.

### BRIEF DESCRIPTION OF THE DRAWINGS

FIG. 1 is a perspective view of the heat dissipation structure of a LED light of the present invention.

FIG. 2 is a perspective exploded view of the heat dissipation structure of a LED light of the present invention.

FIG. 3 is a sectional view of the heat dissipation structure of a LED light of the present invention.

FIG. 4 is a plan view of the heat dissipation structure of a LED light of the present invention.

### DETAILED DESCRIPTION OF THE PREFERRED EMBODIMENTS

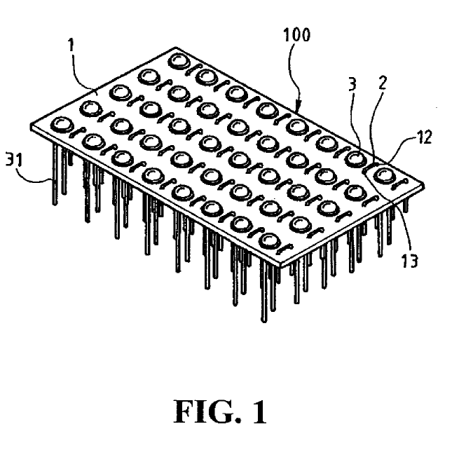

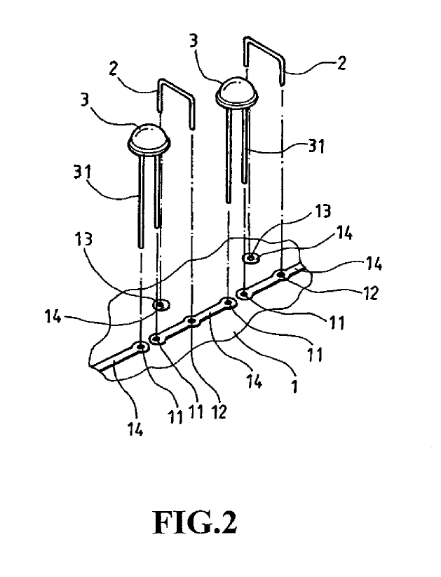

Referring to FIGS. 1, 2 and 3, there is shown a heat dissipation structure of LED light which comprises a securing plate 1; and a plurality of heat conductive elements 2. The securing plate 1 is provided with a plurality of first connection holes 11 and of second connection holes 12 and of third connection holes 13, in parallel with and corresponding with the second connection holes 12 such that the first and second connection holes 11, 12 are connected by the conductive layer 14, and the third connection holes 13 is provided with the conductive layer 14. In the preferred embodiment, the securing plate 1 is a printed circuit board and the conductive layer 14 is printed circuit laying on the securing plate 1. The printed circuit of the conductive layer is either single face or double faces.

In the preferred embodiment, the heat conductive element 2 is substantial an inverted U-shaped structure having iron legs for soldering, or other metal that allows soldering.

In combination, as shown in figure, a plurality of LED 3 is inserted onto the first connection holes 11 by the connection leg 31, and the length of the connection leg 31 is reserved. The heat conductive element 2 is respectively inserted onto the second connection hole 12 and the third connection hole 13 so as to cause the connection leg 31 of LED 3 and the heat conduction element 2 to respectively soldered to the conductive layer 14 of the securing plate 1.

In view of the above combination, a LED light 100 is formed. After current passes through the conductive layer 14, LED 3 is lighted. When LED 3 is lighted, the heat generated is dissipated via the extended surface formed by the reserved length of the connection leg 31 of LED 3, the conductive layer 14, and the heat conductive element 2 between the connection legs 31 of the individual LED 3. Thus, LED light 100 can be manufactured easily and the capacity of the LED can be reduced, and the heat dissipation performance is improved.

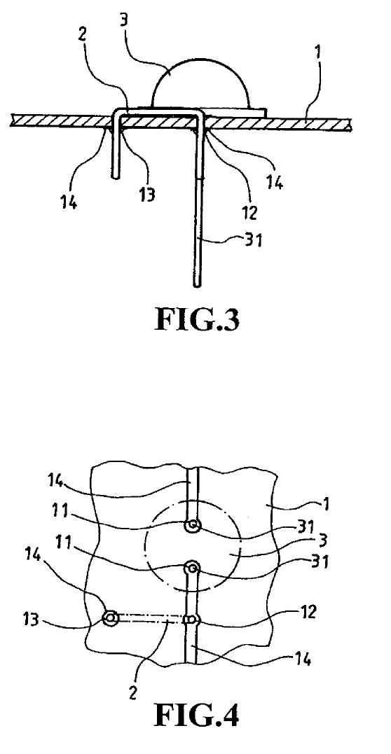

As shown in FIG. 3, there is shown a preferred embodiment of the present invention. The heat conductive elements 2 are respectively linked to the connection legs 31 of LED 3 and across the second connection hole 12 and the third connection hole 13, such that when LED 3 is lighted, the heat generated is dissipated via the extended surface formed by the reserved length of the connection leg 31 of the LED 3, and the conductive layer 14 of the securing plate 1, and the bent, heat conductive element 2.

Referring to FIG. 4, there is shown a plan view of the LED light. The connection leg 31 of the LED 3 is soldered to the first connection hole 11, the heat conductive elements 2 are respectively soldered at the second and third connection holes 12, 13. When LED 3 is lighted, the heat generated is dissipated via the reserved length of the connection leg 31 of LED 3 and the extended surface formed by the connection of the conductive layer 14 of the securing plate 1. Further, a partial of heat is also dissipated by the bent heat conductive element 2 of the second connection hole 12 and the third connection hole 13. The extended surface thus formed is used to dissipate heat.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A heat dissipation structure of a LED light comprising
(a) a securing plate having a plurality of first connection holes and second connection holes and third connection holes in parallel with and in corresponding with the second connection holes such that the first connection holes and the second connection holes are mutually connected with a conductive layer, wherein the third connection holes are provided with an independent conductive layer;
(b) a plurality of LED connected onto the connection holes of the securing plate and soldered onto the conductive layer of the securing plate;
(c) a heat conductive element connected onto the second and third connection hole of the securing plate and soldered onto the conductive layer of the securing plate;
thereby where the LED lights, generated heat is dissipated via the extended area formed by the conductive layer of the securing plate and the connection legs of a specific extended length of the LED and the conductive elements connected to the LED legs.

2. The heat dissipation structure of claim 1, wherein the heat conductive element is a substantially inverted “U” shaped with legs made from iron for soldering or other metal which is solderable.

3. The heat dissipation structure of claim 1, wherein the securing plate is a circuit board and the conductive layer is printed circuit on the circuit board.

4. The heat dissipation structure of claim 3, wherein the printed circuit is either single face or double faces which enhance(s) area for heat dissipation.
